(19) United States
(12) Patent Application Publication
(10) Pub. No.: US 2026/0210526 A1
(43) Pub. Date: Jul. 23, 2026

(54) REFLECTOR ASSEMBLY USING MULTI-LIGHT-SOURCE FOR CHANGING ILLUMINATION EFFECT

(71) Applicant: NITELAB OPTOELECTRONICS CO., LTD., Foshan (CN)

(72) Inventor: Wenjie Li, Foshan (CN)

(21) Appl. No.: 19/235,849

(22) Filed: Jun. 12, 2025

(30) Foreign Application Priority Data
Jan. 20, 2025 (CN) 202510087406.6

(51) Int. Cl. F21V 7/04; F21V 7/00; F21V 7/10; F21Y 113/00

(52) U.S. Cl. CPC F21V 7/045; F21V 7/0025; F21V 7/10; F21Y 2113/00

(57) ABSTRACT

The present invention relates to a reflector assembly using a multi-light-source for changing illumination effect, comprising a reflector cup, a first light source and a plurality of second light sources around the first light source; a reflective curved surface is formed at an inner wall surface of the reflector cup having a light inlet and a light outlet; when turned on simultaneously, the light rays emitted by the first and second light sources form first and second light spots through the light outlet respectively; an interval region is formed between the first and second light spots, and a microstructured reflective part for reflecting part of the light rays emitted by the first or/and the second light sources towards the interval region is formed on the reflective curved surface along its circumference. Since microstructured reflective part is provided, the effect of improving the aesthetics of the light spot is achieved.

### CROSS REFERENCE TO RELATED APPLICATIONS

The present application claims the benefit of Chinese Patent Application No. 202510087406.6 filed on Jan. 20, 2025, the contents of which are incorporated herein by reference in their entirety.

### TECHNICAL FIELD

The present invention relates to the field of lighting technology, and more specifically, to a reflector assembly using a multi-light-source for changing illumination effect.

### BACKGROUND

For the purpose of achieving changes in the illumination angle or the illumination distance of a single lamp, there are currently two mainstream methods as follows. The first one is to use a single optical component in conjunction with a mechanical structure to change the distance between the light source and the optical component to achieve changes in the light spot, while additional structural components make the structure of the lamp itself to be complex and large (lightweight and miniaturization are the development trend especially in the field of portable lamps), and moreover, manual adjustment of the focal length is uncontrollable and precise adjustment cannot be achieved. The second one is to use multiple optical components to deflect light rays. However, due to that the light rays pass through multiple optical components of the system, the overall efficiency of the optical system is significantly reduced, and additional optical components need to be assembled and disassembled, which has a negative impact on the integrity of the product.

The above two solutions have the following problems: relatively low overall optical system efficiency, increased cost of the lamp, complex structure or high cost and other defects.

In order to solve the above problems, a patent application filed on the same day as the prior application uses multiple crystal elements (center light source and surrounding light sources), and the illumination angle and distance may be changed by controlling the center light source and surrounding light sources separately. However, due to the use of the solution of the independent control of the central light source and the surrounding light sources, when designing optical components, the light emission planes of the central light source and the surrounding light sources cannot be regarded as even light ray emission planes. As the interval between the central light source and the surrounding light sources (the interval between crystal elements) is still considered as a non-energy-radiation region, after light rays emitted by central light source and the surrounding light sources being deflected or reflected by the optical device, it is easy to preform project imaging in the non-energy-radiation region. The spatial distribution of its light rays can be seen in FIG. 9, and the curve in FIG. 9 shows the depression m. The light spot on the illumination plane can be seen in FIG. 10, and there is a clear dark region in the light spot, which affects the aesthetics of the light spot.

### SUMMARY

In order to overcome the problem of affecting the aesthetics of the light spot in the prior art, the present invention provides a reflector assembly using a multi-light-source for changing illumination effect. The aesthetics of the light spot is affected by a solution used in the prior art that the central light source and the surrounding light sources independently controlled to achieve changes in the illumination angle or the illumination distance of the lamp.

To solve the above technical problems, the technical solution adopted by the present invention is follows: a reflector assembly using a multi-light-source for changing illumination effect comprises a reflector cup; a first light source and a plurality of second light sources; the first light source and the second light sources are independently controlled from each other; the plurality of the second light sources are arranged around the first light source, the reflector cup has a light inlet and a light outlet; and the first light source and the second light sources are located in the light inlet; a reflective curved surface for reflecting light rays emitted by the first light source and the second light sources is formed at an inner wall surface of the reflector cup; when the first light source and the second light sources are turned on simultaneously, the light rays emitted by the first light source forms a first light spot through the light outlet, and the light rays emitted by the second light sources forms a second light spot through the light outlet; an interval region is formed between the first light spot and the second light spot, and a microstructured reflective part for reflecting part of the light rays emitted by the first light source or/and the second light sources towards the interval region is formed on the reflective curved surface along circumference of the reflective curved surface.

In the technical solution of the application, when only the first light source is turned on, the light rays emitted by the first light source finally forms one first light spot that is approximately perfect circular after passing through the light outlet. When there is no microstructured reflective part formed on the reflective curved surface, and when both the first light source and the second light sources are turned on, the light rays emitted by the first light source finally forms one first light spot that is approximately perfect circular after passing through the light outlet, and the light rays emitted by the second light sources finally form one larger second light spot that is approximately annular after passing through the light outlet, and the second light spot is located on an outer periphery of the first light spot. Due to the interval between the first light source and the second light source, the interval region is formed between the second light spot and the first light spot. And due to that the microstructured reflective part for reflecting part of the light rays emitted by the first light source or/and the second light sources towards the interval region is formed on the reflective curved surface along circumference of the reflective curved surface, the microstructured reflective part is capable of reflecting part of the light rays emitted by the first light source or/and the second light sources towards the interval region, thereby increasing the luminous flux of the interval region and achieving the effect of improving the aesthetics of the light spot.

Furthermore, the microstructured reflective part is distributed in shape of an annular band on the reflective curved surface, and the microstructured reflective part comprises several rings of spherical base circles formed on the reflective curved surface. Each base circle refers to single-reptilia. In the present technical solution, as the microstructured reflective part comprises several spherical base circles, the base circles have a spherical shape and the spherical shape of the base circles may change the angle of reflection of the light rays. Each base circle is one reflective unit, and numerous reflective units are distributed in shape of an annular band on the reflective curved surface, which can change the angle of light rays projected there and reflect the light rays onto the dark spot region to enhance the luminous flux of the dark spot region, achieving the effect of improving the aesthetic appeal of the light.

Furthermore, two adjacent base circles in a same ring partially overlap, and two adjacent base circles in two adjacent rings partially overlap. In the present technical solution, due to the partial overlap between the two adjacent base circles in the same ring and the partial overlap between the two adjacent base circles in the two adjacent rings, the distance between the two adjacent base circles is reduced, such that more base circles are distributed in the microstructured reflective part, thereby obtaining more reflective base circles with different curvatures, with better light mixing effect, avoiding the phenomenon of chip imaging of the light spot, and enhancing the reflection effect on the light rays.

Furthermore, a radius of the base circle is r, a center-to-center distance between two base circles corresponding to each other in two adjacent rings is D, and a center-to-center distance between two adjacent base circles in the same ring is d.

Furthermore, a range of the radius r of the base circle is 0.5 mm<r<2.2 mm.

Furthermore, a range of the center-to-center distance D is 0.04 mm<D<r.

Furthermore, a range of the center-to-center distance d is 0.05 mm<d<1 mm.

Furthermore, all the base circles in two adjacent rings are concentric along a circumferential array, and a number of the base circles in the same ring is N, and N=2*π*n*D/d, where n is a positive integer and represents density of all the base circles in the same ring.

Furthermore, a vertical height (i.e., vertical distance) between the light inlet and the light outlet is h, the microstructured reflective part extends from a position of the light inlet towards a direction of the light outlet to a middle position of the reflective curved surface, and a vertical height between the microstructured reflective part and the light inlet is P, where P=h*0.6*tan 30°, and h represents a height of the reflector cup (i.e., a vertical height between the light inlet and the light outlet).

Furthermore, a generatrix function of the reflective curved surface is as follows:

$$y = {( x + \frac{2 * \sqrt{h + i} - k}{2} )}^{2}$$

where a light emitting plane of the first light source is flush with a light emitting plane of the second light sources, a vertical distance between the light emitting plane and the light inlet is i, a height of the reflector cup is h, and a caliber of the light outlet is k.

Compared with the prior art, the beneficial effects of the technical solution of the present invention are as follows:

In the present invention, due to that the microstructured reflective part for reflecting part of the light rays emitted by the first light source or/and the second light sources towards the dark spot region is formed on the reflective curved surface along circumference of the reflective curved surface, the microstructured reflective part is capable of reflecting part of the light rays emitted by the first light source or/and the second light sources towards the interval region, thereby increasing the luminous flux of the interval region and achieving the effect of improving the aesthetics of the light spot.

### BRIEF DESCRIPTION OF THE DRAWINGS

FIG. 1 is a schematic diagram of the structure of a first light source and a second light source being packaged.

FIG. 2 is a schematic diagram of a generatrix of cross-section of the reflector cup and of a coordinate system.

FIG. 3 is a schematic diagram of the relative position relationship between the reflector cup, the first light source, and the second light source.

FIG. 4 is a schematic diagram of the relative position of a reflective structure on a reflective curved surface of the reflector cup.

FIG. 5 is a diagram of an optical path when only the first light source is turned on in the reflector assembly.

FIG. 6 is a graph of a light distribution curve of the reflector assembly (without reflective structure) when only the first light source is turned on.

FIG. 7 is a graph of the true color light spot of the reflector assembly (without reflective structure) when only the first light source is turned on.

FIG. 8 is a diagram of the optical path of the reflector assembly (without reflective structure) when the first second light source and the second light sources are turned on.

FIG. 9 is a graph of the light distribution curve of the reflector assembly (without reflective structure) when the first second light source and the second light sources are turned on.

FIG. 10 is a graph of the true color light spot of the reflector assembly (without reflective structure) when the first second light source and the second light sources are turned on.

FIG. 11 a diagram of the optical path of the reflector assembly (with a reflective structure) when the first second light source and the second light sources are turned on.

FIG. 12 is a graph of the light distribution curve of the reflector assembly (with a reflective structure) when the first second light source and the second light sources are turned on.

FIG. 13 a graph of the true color light spot of the reflector assembly (with a reflective structure) when the first second light source and the second light source are turned on.

FIG. 14 is a schematic diagram of the structure of part of the base circles distributed along a circular array.

FIG. 15 shows the positional relationship between two adjacent base circles in two adjacent rings.

FIG. 16 shows the positional relationship between two adjacent base circles in the same ring.

In the figures: 1. reflector cup; 2. first light source; 3. second light source; 11. light inlet; 12. light outlet; 13. reflective curved surface; 4. first light spot; 5. second light spot; 6. interval region; 7. microstructured reflective part; 71. base circle.

### DESCRIPTION OF THE EMBODIMENTS

The accompanying drawings are for illustrative purposes only and should not be construed as a limitation on this patent, for the purpose of better illustrating the present embodiments, certain components in the accompanying drawings may be omitted, enlarged or reduced, and do not represent the size of an actual product. The description of the positional relationship in the accompanying drawings is for illustrative purposes only and should not be construed as a limitation on this patent.

The same or similar reference numerals in the accompanying drawings of the embodiments of the present invention correspond to the same or similar components; In the description of the present invention, it should be understood that if there are terms such as “up”, “down”, “left”, “right”, “long”, “short” indicating orientation or position relationships based on the orientation or position relationships shown in the drawings, it is only for the convenience of describing the present invention and simplifying the description, and does not indicate or imply that the device or component referred to must have a specific orientation, be constructed and operated in a specific orientation. Therefore, the wording used to describe the position relationships in the drawings is only for illustrative purposes and should not be construed as a limitation on this patent. For ordinary skilled persons in the art, the specific meanings of the above terms can be understood according to specific situations.

The following provides a further detailed description of the technical solution of the present invention through specific embodiments and in conjunction with the accompanying drawings:

### Embodiment 1

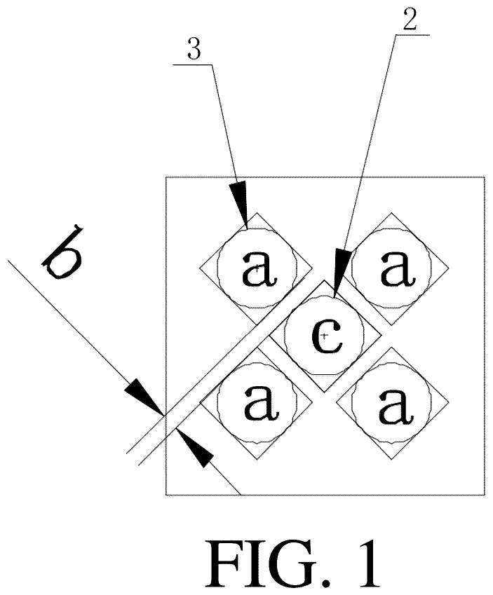

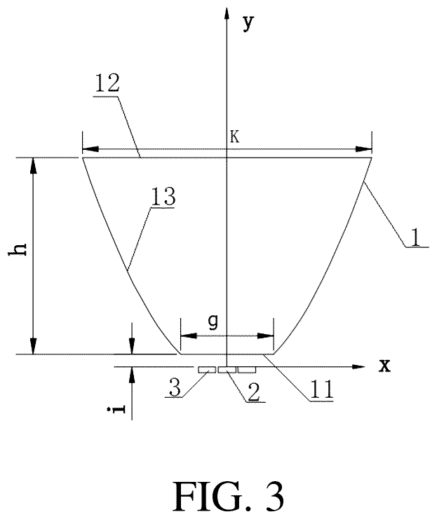

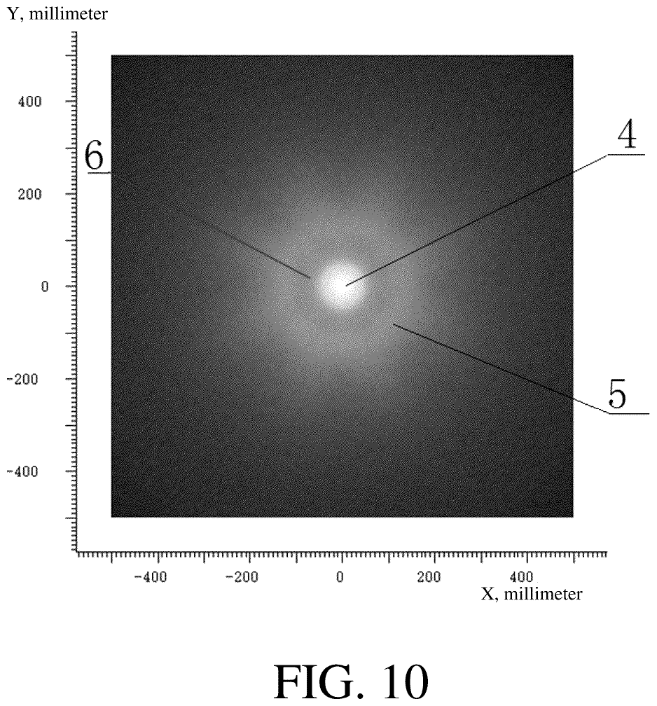

As shown in FIG. 1, FIG. 3, and FIG. 10, a reflector assembly using a multi-light-source for changing illumination effect. The reflector assembly comprises a reflector cup 1, a first light source 2 and a plurality of second light sources 3. The first light source 2 and the second light sources 3 are independently controlled from each other. The plurality of the second light sources 3 are arranged around the first light source 2. The reflector cup 1 has a light inlet 11 and a light outlet 12, and the first light source 2 and the second light sources 3 are located in the light inlet 11. A reflective curved surface 13 for reflecting light rays emitted by the first light source 2 and the second light sources 2 is formed at an inner wall surface of the reflector cup 1. When the first light source 2 and the second light sources 3 are turned on simultaneously, the light rays emitted by the first light source 2 forms a first light spot 4 through the light outlet 12, and the light rays emitted by the second light sources 3 forms a second light spot 5 through the light outlet 12. An interval region 6 is formed between the first light spot 4 and the second light spot 5, and a microstructured reflective part 7 for reflecting part of the light rays emitted by the first light source 2 or/and the second light sources 3 towards the interval region 6 is formed on the reflective curved surface 13 along circumference of the reflective curved surface 13.

In the present embodiment, when only the first light source 2 is turned on, the light rays emitted by the first light source 2 finally forms one first light spot 4 that is approximately perfect circular after passing through the light outlet 12. When there is no microstructured reflective part 7 formed on the reflective curved surface 13, and when both the first light source 2 and the second light sources 3 are turned on, the light rays emitted by the first light source 2 finally forms one first light spot 4 that is approximately perfect circular after passing through the light outlet 12, and the light rays emitted by the second light sources 3 finally form one larger second light spot 5 that is approximately annular after passing through the light outlet 12, and the second light spot 5 is located on the outer periphery of the first light spot 4. Due to the minimum interval (spacing between crystal elements) between the first light source 2 and the second light sources 3, the interval region 6 is formed between the second light spot 5 and the first light spot 4. And due to that the microstructured reflective part 7 for reflecting part of the light rays emitted by the first light source 2 or/and the second light sources 3 towards the interval region 6 is formed on the reflective curved surface 13 along circumference of the reflective curved surface 13, the microstructured reflective part 7 is capable of reflecting part of the light rays emitted by the first light source 2 or/and the second light sources 3 towards the interval region 6, thereby increasing the luminous flux of the interval region 6 and achieving the effect of improving the aesthetics of the light spot.

It should be noted that in order to achieve that the microstructured reflective part 7 on the reflective curved surface 13 is capable of reflecting part of the light rays emitted by the first light source 2 or/and the second light sources 3 towards the interval region 6, it may be achieved by configuring the structure of microstructured reflective part 7. It may also be achieved that part of the light rays emitted by the first light source 2 or/and the second light sources 3 is reflected towards the interval region 6 by changing the reflective curvature of the microstructured reflective part 7. It should also be pointed out that the first light source 2 is the central light source, and all the second light sources 3 are uniformly distributed along the circumferential direction on the outer side of the first light source 2 while taking the first light source 2 as a center. It should be noted that the light emitting planes of the first light source 2 and of the second light source 3 may be in the same plane, and the first light source 2 and the second light sources 3 may be packaged together.

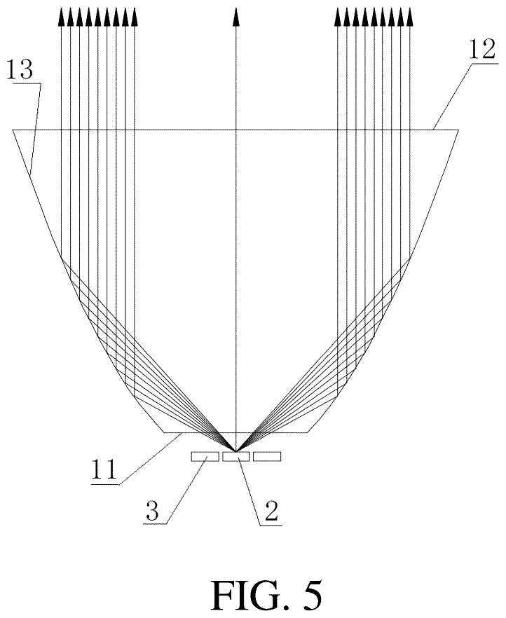

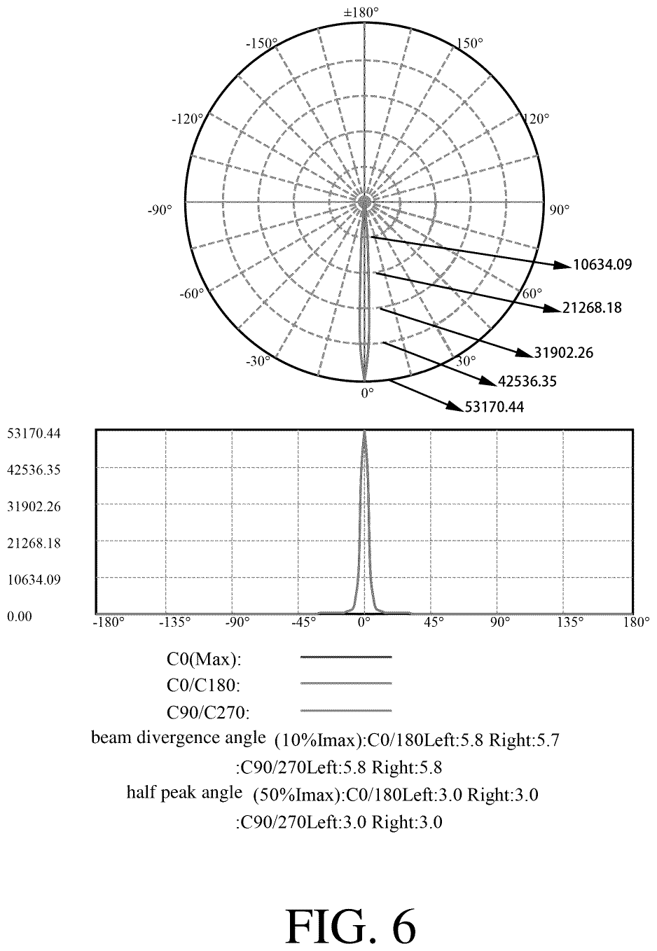

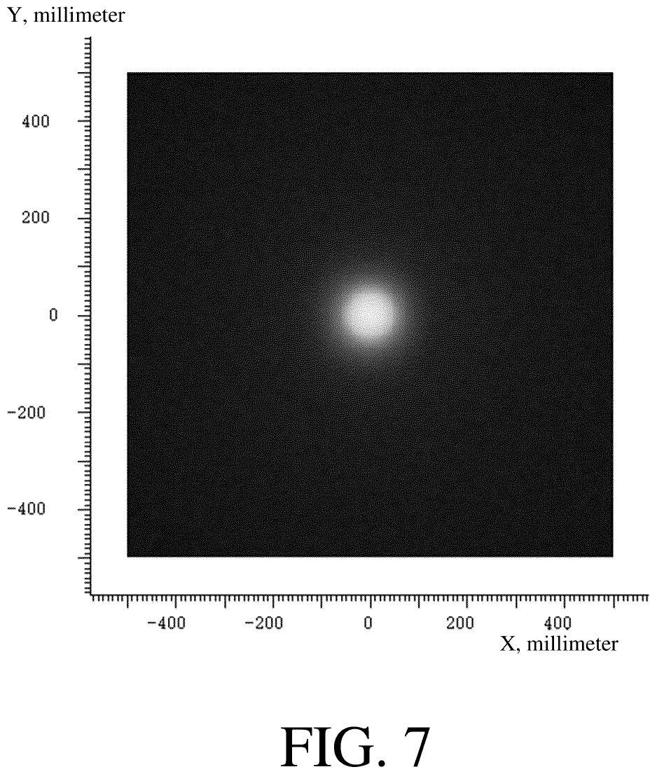

It should also be pointed out that the first light source 2 and the second light sources 3 are respectively connected to a control circuit. The control circuit may turn on the first light source 2 separately or simultaneously turn on the first light source 2 and the second light sources 3. When the control circuit makes the first light source 2 emit light rays, as shown in FIG. 5, some of the incident light rays are vertically emitted to reach the receiving surface, while another part of the incident light rays are reflected by the reflective curved surface 13 and emitted from the light outlet 12 of the reflector cup 1 in an approximately collimated state. There are also some incident light rays that are not reflected by the reflective curved surface 13 and are emitted in a non-vertical manner. This part of the light rays may be considered to be unable to reach the receiving surface, so it does not be discussed in the present embodiment. All emitted light rays reach the illuminated surface to form a small light spot that is approximately perfect circular, with minimal changes in the illuminance gradient at each point on the light spot. The true color light spot graph can be referred to FIG. 7 in detail, and the spatial distribution of the light rays is reflected in the light distribution curve diagram, as shown in FIG. 6. And it can be known from reading the graph that the half peak angle is 6°.

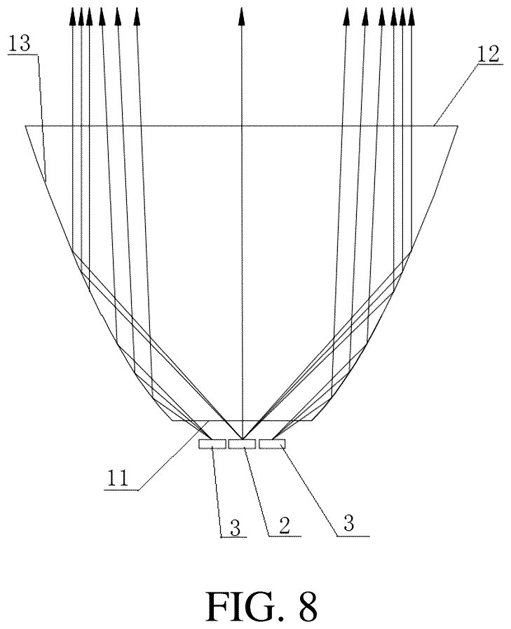

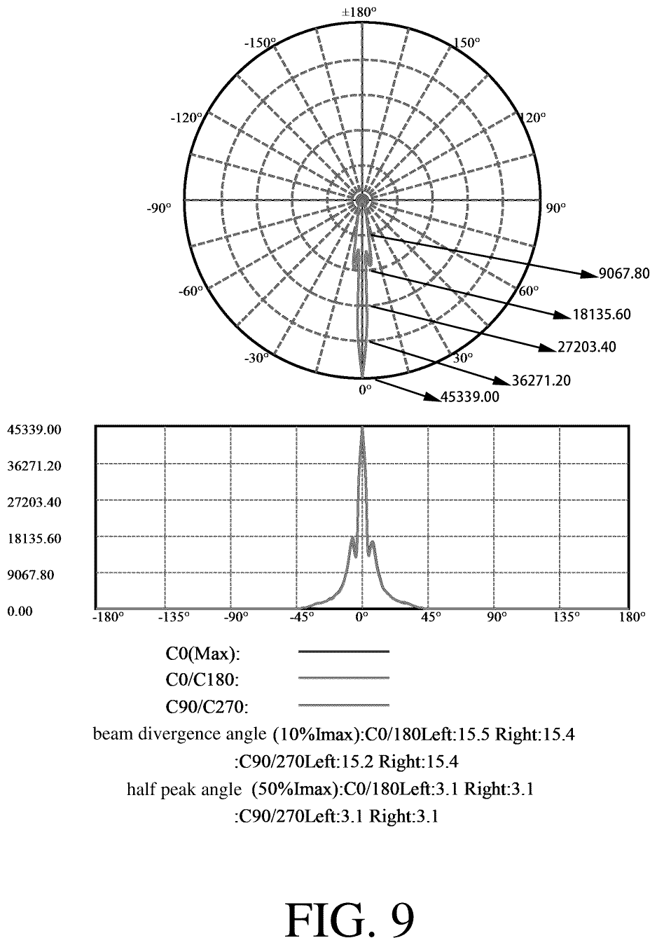

When there is no microstructured reflective part 7 formed on the reflective curved surface 13, the control circuit makes the first light source 2 and the second light sources 3 emit light rays simultaneously. At this time, the optical path length is shown in FIG. 8, and the light distribution curve is shown in FIG. 9. At the same time, it can be seen that there is a significant depression m in the light distribution curve. This phenomenon caused by the minimum gap b between the first light source 2 and the second light source 3, which is considered as non-energy-radiation region where project imaging is easily performed. Finally, the true color light spot graph is projected onto the illumination plane, referring to FIG. 10. It can be seen that a dark spot is formed in the interval region 6 on the illumination plane, which is not aesthetically pleasing and affects the overall aesthetic effect of the light.

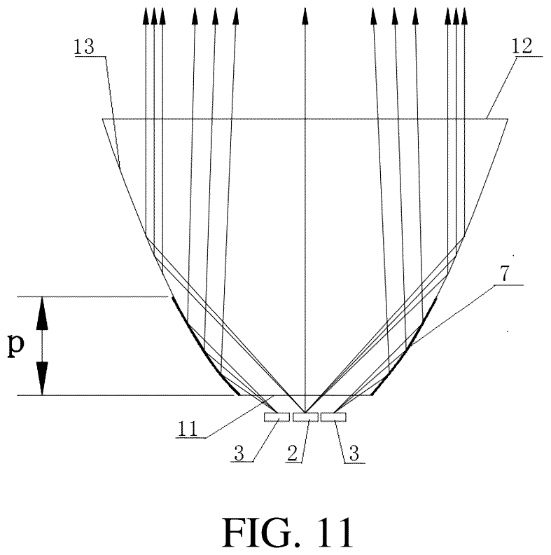

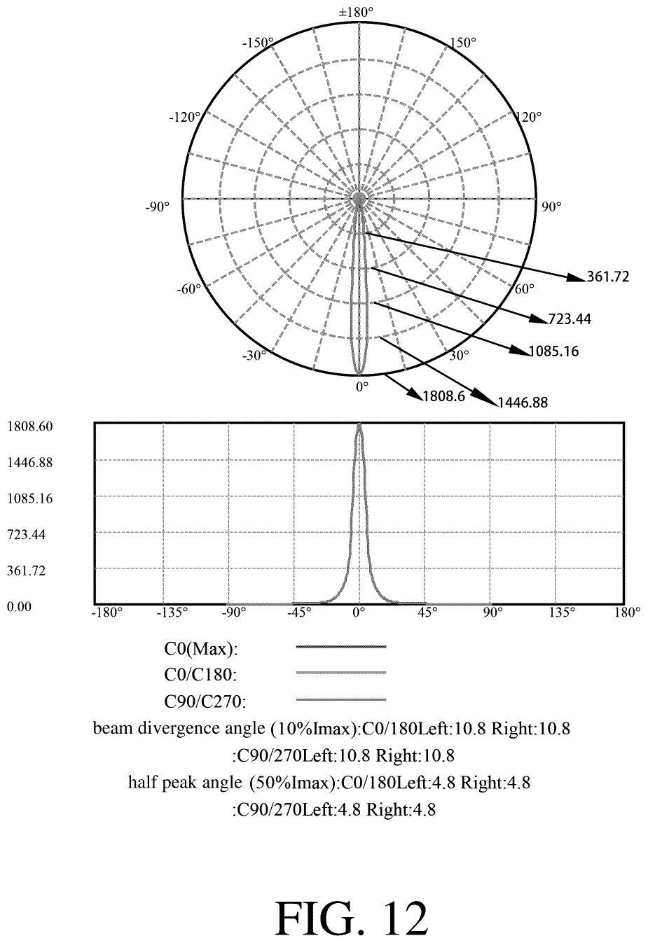

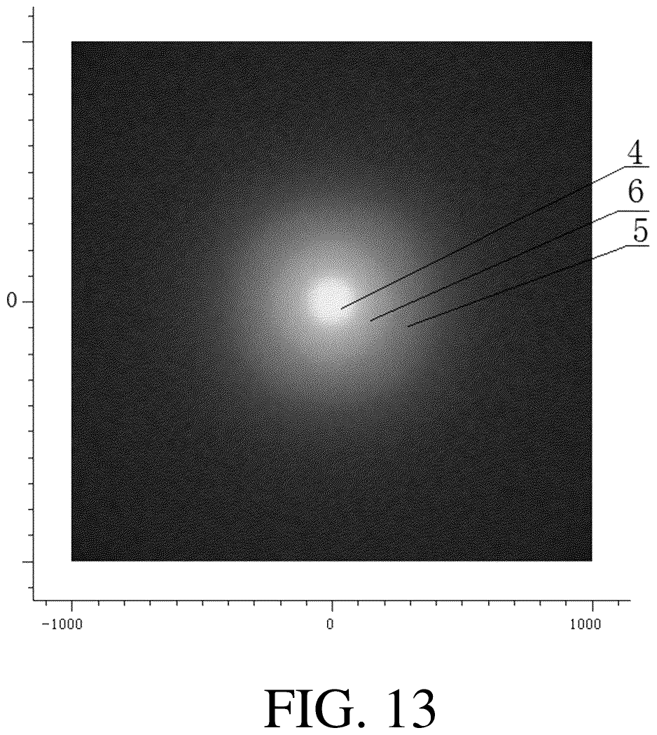

When the microstructured reflective part 7 is formed on the reflective curved surface 13, and the control circuit makes the first light source 2 and the second light sources 3 emit light rays simultaneously, the optical path at this time is shown in FIG. 11. When some light rays are under the action of the microstructured reflective part 7, the angle of reflection changes, and the light distribution curve is shown in FIG. 12. It can be seen that the curvature of the light distribution curve is continuous and there is no depression. Finally, the true color light spot graph projected onto the illumination plane is shown in FIG. 13. It can be clearly seen that the dark spot in the interval region 6 has disappeared significantly, and it can be known from reading the graph that the half peak edge angle is 10°.

From this, it can be seen that without moving the reflector cup or adding new structural components, the illumination distance and angle of the lamp can be changed by simply controlling the switches of the first light source 2 and the second light sources 3 respectively. The aesthetic appeal of the light spot can be enhanced by arranging microstructured reflective part 7 on the reflective surface.

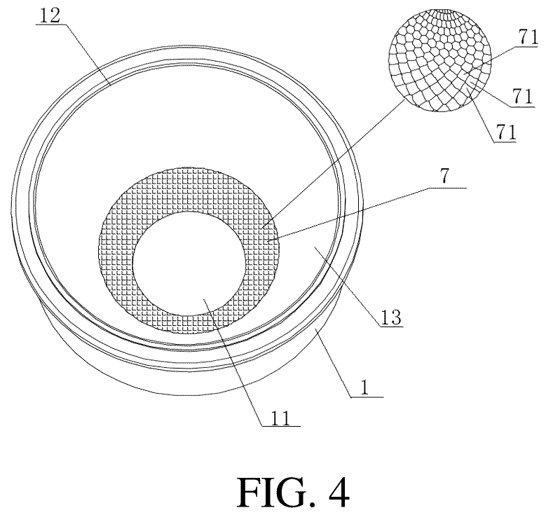

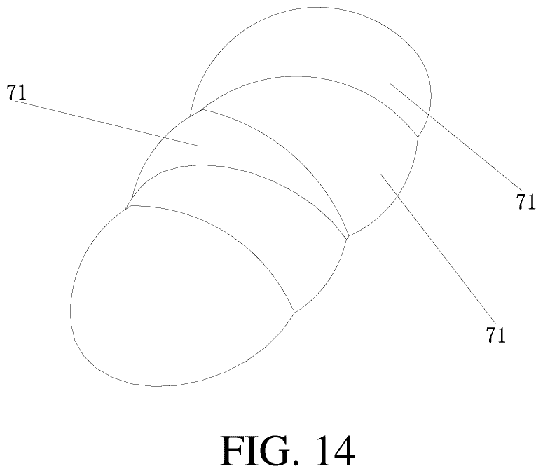

As shown in FIG. 4 and FIG. 14, the microstructured reflective part 7 is distributed in a shape of an annular band on the reflective curved surface 13. The microstructured reflective part 7 comprises several spherical base circles 71 formed on the reflective curved surface 13. Specifically, the base circles 71 may be distributed in a circular array on the reflective curved surface 13. In the present technical solution, as the microstructured reflective part 7 includes several spherical base circles 71, the base circles have a spherical shape and the spherical shape of the base circles 71 may change the angle of reflection of the light rays. Each base circle 71 is one reflective unit, and numerous reflective units are distributed in shape of an annular band on the reflective curved surface 13, which can change the angle of light rays projected there and reflect the light rays onto the interval region 6 to enhance the luminous flux of the interval region 6, achieving the effect of improving the aesthetic appeal of the light.

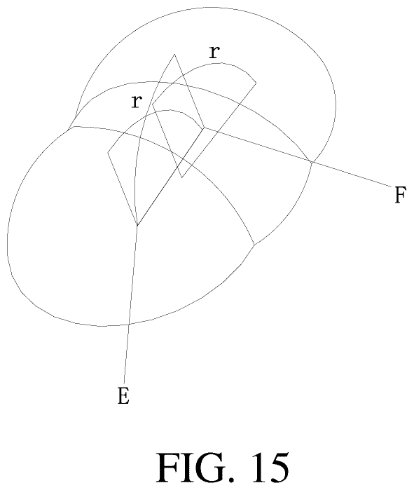

As shown in FIG. 14 and FIG. 15, two adjacent base circles 71 in the same ring partially overlap, and two adjacent base circles 71 in two adjacent rings partially overlap. Due to the partial overlap between two adjacent base circles 71 in the same ring and the partial overlap between the two adjacent base circles 71 in the two adjacent rings, the distance between the two adjacent base circles is reduced, such that more base circles 71 are distributed in the microstructured reflective part 7, thereby obtaining more reflective base circles 71 with different curvatures, with better light mixing effect, avoiding the phenomenon of chip imaging of the light spot, and enhancing the reflection effect on light rays.

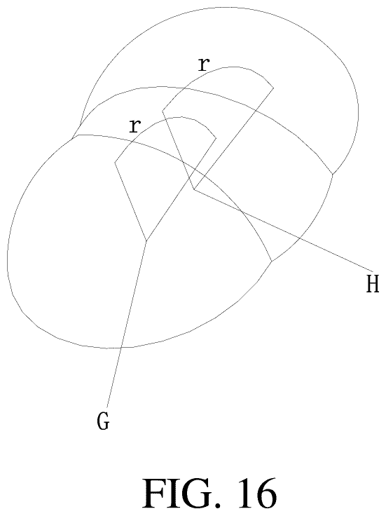

In addition, the radius of the base circle 71 is r, and the center-to-center distance between the two base circles 71 corresponding to each other in two adjacent circles is D. As shown in FIG. 15, the centers of the two base circles 71 in the two adjacent rings are points E and F, respectively, where the distance between points E and F is the distance D between the two base circles corresponding to each other in the two adjacent circles. The center-to-center distance between two adjacent base circles 71 in the same ring is d, as shown in FIG. 16. The centers of the two base circles 71 in the same ring are points G and H, respectively. The distance between points G and H is the center-to-center distance d between the two adjacent base circles 71 in the same ring.

The range of the radius r of the base circle is 0.5 mm<r<2.2 mm.

In addition, the range of the center-to-center distance D is 0.04 mm<D<r.

The range of the center-to-center distance d is 0.05 mm<d<1 mm.

In addition, all the base circles 71 of two adjacent circles are concentric along a circumferential array, and the number of the base circles in the same ring is N, and N=2*π*n*D/d, where n is a positive integer and represents density of all the base circles in the same ring.

### Embodiment 2

The difference between the present embodiment and embodiment 1 lies in that the vertical height (i.e., vertical distance) between the light inlet 11 and the light outlet 12 is h, and the microstructured reflective part 7 extends from the position of the light inlet 11 towards a direction of the light outlet 12 to the middle position of the reflective curved surface 13, and the vertical height between the microstructured reflective part 7 and the light inlet 11 is P, where P=h*0.6*tan 30° and h represents a height of the reflector cup (i.e., a vertical height between the light inlet 11 and the light outlet 12).

### Embodiment 3

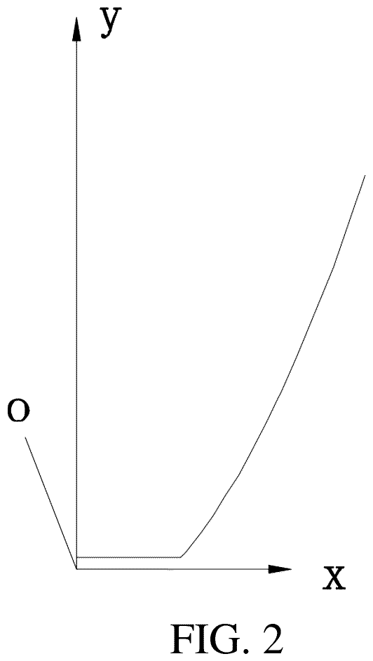

The difference between the present embodiment and embodiment 1 lies in that the light emitting plane of the first light source 1 is flush with the light emitting plane of the second light sources 2, the vertical distance between the light emitting planes of the first light source 1 and the second light sources 2 and the light inlet 11 of the reflector cup 1 is i. The height of the reflector cup 1 is h (i.e. the vertical distance between the light inlet 11 and the light outlet 12), the caliber of the light outlet 12 is k. A coordinate system is established by taking the center point of the light emitting plane of the first light source 2 as the origin O. FIG. 2 is a schematic diagram of the generatrix of the cross-section of the reflector cup and of the coordinate system, and a functional relationship is established to obtain the generatrix of the reflective curved surface 13. The functional relationship of the generatrix is as follows:

$$y = {( x + \frac{2 * \sqrt{h + i} - k}{2} )}^{2}$$

And take a point in the first quadrant of the coordinate system to solve the quadratic curve mentioned above. The quadratic curve is the generatrix of the reflective curved surface 13 of the reflector cup 1. Then, rotate the quadratic curve with the Y-axis as the rotation axis to obtain a curved surface which is the reflective curved surface 13 of the reflector cup. The reflective curved surface 13 is a smooth mirror surface. The range of y is i≤y≤i+h. The diameters of the first light source 2 and the second light sources 3 are Φ, and the diameter k of the light outlet 12 of the reflector cup 1 is 5.5 to 7.2 times the diameter of Φ. The height h of reflector cup 1, the diameter k of the light outlet 12 of the reflector, and the vertical distance i between the light emitting plane (the light emitting plane of the first light source 2 and the second light sources 3) of the package and the light inlet at the bottom of reflector cup 1 satisfy the following mathematical relationship: h=0.7*k−i.

Obviously, the above embodiments of the present invention are only examples provided to clearly illustrate the present invention, and are not limitations on the embodiments of the present invention. Those of ordinary skill in the art may also make other changes or variations in different forms on the basis of the above description. It is unnecessary and impossible to enumerate all embodiments herein. Any modifications, equivalent substitutions, improvements, etc. made within the spirit and principle of the present invention should be included within the scope of protection of the claims of the present invention.

1. A reflector assembly using a multi-light-source for changing illumination effect, wherein the reflector assembly comprises a reflector cup (1), a first light source (2) and a plurality of second light sources (3), the first light source (2) and the second light sources (3) are independently controlled from each other, the plurality of the second light sources (3) are arranged around the first light source (2), the reflector cup (1) has a light inlet (11) and a light outlet (12), and the first light source (2) and the second light sources (3) are located in the light inlet (11), a reflective curved surface (13) for reflecting light rays emitted by the first light source (2) and the second light sources (2) is formed at an inner wall surface of the reflector cup (1);
when the first light source (2) and the second light sources (3) are turned on simultaneously, the light rays emitted by the first light source (2) forms a first light spot (4) through the light outlet (12), and the light rays emitted by the second light sources (3) forms a second light spot (5) through the light outlet (12); an interval region (6) is formed between the first light spot (4) and the second light spot (5), and a microstructured reflective part (7) for reflecting part of the light rays emitted by the first light source (2) or/and the second light sources (3) towards the interval region (6) is formed on the reflective curved surface (13) along circumference of the reflective curved surface (13);
wherein the microstructured reflective part (7) is distributed in a shape of an annular band on the reflective curved surface (13), and the microstructured reflective part (7) comprises several rings of spherical base circles (71) formed on the reflective curved surface (13); and
wherein the microstructured reflective part (7) extends from a position of the light inlet (11) towards a direction of the light outlet (12) to a middle position of the reflective curved surface (13), and a vertical height between the microstructured reflective part (7) and the light inlet (11) is P, wherein P=h*0.6*tan 30° and h represents a height of the reflector cup.

2. (canceled)

3. The reflector assembly using the multi-light-source for changing illumination effect according to claim 2, wherein two adjacent base circles (71) in a same ring partially overlap, and two adjacent base circles (71) in two adjacent rings partially overlap.

4. The reflector assembly using the multi-light-source for changing illumination effect according to claim 3, wherein a radius of the base circle (71) is r, a center-to-center distance between two base circles (71) corresponding to each other in two adjacent rings is D, and a center-to-center distance between two adjacent base circles (71) in the same ring is d.

5. The reflector assembly using the multi-light-source for changing illumination effect according to claim 4, wherein a range of the radius r of the base circle (71) is 0.5 mm<r<2.2 mm.

6. The reflector assembly using the multi-light-source for changing illumination effect according to claim 5, wherein a range of the center-to-center distance D is 0.04 mm<D<r.

7. The reflector assembly using the multi-light-source for changing illumination effect according to claim 4, wherein a range of the center-to-center distance d is 0.05 mm<d<1 mm.

8. The reflector assembly using the multi-light-source for changing illumination effect according to claim 4, wherein all the base circles (71) in two adjacent rings are concentric along a circumferential array, and a number of the base circles (71) on the same ring is N, and N=2*π*n*D/d, wherein n is a positive integer and represents density of all the base circles (71) in the same ring.

9. (canceled)

10. The reflector assembly using the multi-light-source for changing illumination effect according to claim 1, wherein a generatrix function of the reflective curved surface (13) is as follows:
$$y = {( x + \frac{2 * \sqrt{h + i} - k}{2} )}^{2}$$
wherein, a light emitting plane of the first light source (2) is flush with a light emitting plane of the second light source (3), a vertical distance between the light emitting plane and the light inlet (11) is i, a height of the reflector cup (1) is h, and a caliber of the light outlet (12) is k.
